(19) United States
(12) Patent Application Publication
(10) Pub. No.: US 2013/0243903 A1
(43) Pub. Date: Sep. 19, 2013

(54) PHYTASE IN READY-TO-DRINK SOFT DRINKS

(71) Applicants: Gabriela Badolato Bönisch, Basel (CH); Robert Beudeker, Basel (CH); Sylvia P. Poulos, Atlanta, GA (US); Loni Schweikert, Basel (CH); Kurt Vogel, Basel (CH); Karin Wertz, Basel (CH)

(72) Inventors: Gabriela Badolato Bönisch, Basel (CH); Robert Beudeker, Basel (CH); Sylvia P. Poulos, Atlanta, GA (US); Loni Schweikert, Basel (CH); Kurt Vogel, Basel (CH); Karin Wertz, Basel (CH)

(73) Assignee: DSM IP ASSETS B.V., Heerlen (NL)

(21) Appl. No.: 13/816,800

(22) PCT Filed: Aug. 19, 2011
(86) PCT No.: PCT/EP2011/064303

§ 371 Date: May 22, 2013

(30) Foreign Application Priority Data
Aug. 26, 2010 (EP) 10174095.9

(51) Int. Cl. A23L 2/66

(52) U.S. Cl. CPC A23L 2/66
USPC 426/2; 426/61

(57) ABSTRACT

The present invention relates to an acidic ready to drink beverage having a water activity greater than 0.95, a pH value lower than 6, and enriched with an active phytase enzyme.

The present invention relates to a ready to drink phytate free and alcohol free beverage enriched with an active phytase enzyme.

Furthermore, the invention relates to the use of a ready to drink beverage to deliver active phytase to humans, and to correct mineral deficiencies in humans.

Mineral nutrient (so-called micronutrient) deficiency continues to be highly prevalent in developing countries, but is also a concern especially in adolescents, pregnant women, and in vegetarians in developed countries and is therefore an important public health issue.

Iron deficiency (or “sideropenia”) is the most common known form of nutritional deficiency. The direct consequence of iron deficiency is iron deficiency anemia. Mainly infants, children, adolescent girls and women, here especially pregnant and breast feeding women are affected. Of children, especially children from 6 months until 2 to 5 years of age are affected. In the first 6 months of life, infants obtain iron via breast milk. The iron status of the infant depends on the iron status of the mother before conception. After weaning, iron supply to the infant solely depends on the intake from food. In vegetarians, especially in poor countries, the main calorie intake stems from phytate-rich staples, which limits the mineral—including iron—bioavailability. In infants, iron deficiency causes delayed brain and locomotor development and alters emotional development, which cannot be cured by later iron supplementation. Iron deficient infants are less self secure, thus less exploratory, and are less emotionally stable.

Thus, iron deficiency in early infancy reduces the development options of children later in life. In adults, the main obvious impact of iron deficiency is lack of energy, thus reduced physical and cognitive performance, reduced labour productivity, and increased maternal mortality. Because iron is essential for most plants and animals, a wide range of food can provide it. However, these foods are absorbed and processed differently by the body; for instance, iron from meat (heme iron source) is more easily broken down and absorbed than iron in grains (non-heme iron source), and minerals and chemicals in one type of food may inhibit absorption of iron from another type of food eaten at the same time.

Zinc deficiency (or “hypozincemia”) is a condition where insufficient zinc is available for metabolic needs. In fact, one-third of the world population is at risk of zinc deficiency, ranging from 4% to 73% depending on the country. Zinc deficiency is the fifth leading risk factor for disease in the developing world. Providing micronutrients, including zinc, to humans is one of the four quick-win solutions to major global problems identified in the Copenhagen Consensus from an international panel of distinguished economists. Conservative estimates suggest that 25% of the world's population is at risk of zinc deficiency. Populations that consume primarily plant based diets that are low in bioavailable zinc often have zinc deficiencies. Physiological states that require increased zinc include periods of growth in infants and children as well as in mothers during pregnancy. Zinc deficiency is connected with skin and hair problems and suboptimal immune function, as well as delayed sexual maturity especially in boys.

Calcium deficiency (hypocalcemia) is the presence of low serum calcium levels in the blood, usually taken as less than 2.1 mmol/L or 9 mg/dl, or an ionized calcium level of less than 1.1 mmol/L (4.5 mg/dL). It is a type of electrolyte disturbance. In the blood, about half of all calcium is bound to proteins such as serum albumin, but it is the unbound, or ionized, calcium that the body regulates. If a person has abnormal levels of blood proteins, then the plasma calcium may be inaccurate. The ionized calcium level is considered more clinically accurate in this case.

Magnesium deficiency refers to a lack of dietary magnesium below specified levels, which can result in numerous symptoms and conditions. This can generally be remedied by an alteration of diet or oral supplements. However intravenous supplementation is necessary for more severe cases. Symptoms of magnesium deficiency include: hyperexcitability, muscle weakness and tiredness. Severe magnesium deficiency can cause death from heart failure. Calcium as well as phosphorous are needed for bone health and strength during growth phases in child and adulthood, for healing of bone fractures, and to maintain healthy and strong bones throughout life including menopause.

Phytic acid (or phytate when in salt form) is the principal storage form of phosphorous and minerals in many plant tissues, especially bran and seeds. Phytate is found within the hulls and germs of nuts, seeds (including pulses and legumes, such as beans, soya beans, peanuts, peas, chickpeas, lentils and others), and grains (such as wheat, maize/corn, (brown) rice, sorghum, triticale, rye and others). It is a strong chelator of important minerals such as calcium, magnesium, iron and zinc and can therefore contribute to mineral deficiencies in people whose diets rely on these foods for their mineral intake. In this way, phytate is an anti-nutrient.

Phytases are enzymes which split phytic acid (or phytate) in lower inosine phosphate esters, and phytogenic myo-inositol and orthophosphate and therefore increase the bioavailability of occluded minerals. Phytases are—like phytate—found within the hulls and germs of grains and are activated by food processing like soaking, dough processing, fermentation etc. However, the various types of grains do not always have endogenous phytase activity in an amount correlating with the endogenous phytate content. During the production of whole rye meal bread using sourdough, all phytate complexes are split, but only about 50% of the phytate complexes are split during the fermentation process in the making of whole wheat meal bread with yeast. Besides the food processing techniques themselves also physical parameters like particle size of the flour as well as pH value affect the enzymatic degradation of phytate: finely ground grist, low pH and soaking times of several hours promote the liberalization of minerals.

It is known to the person skilled in the art that added phytase can be used during processing of vegetable based nutritious beverage (WO 2009/098182) to reduce the amount of phytate, in order to reduce its anti-nutritional effects, thereby improving the bioavailability of mineral salts. However, for some foods, this is unfortunately not usable since the conditions under which the food is processed are incompatible with the conditions under which the enzyme would exert its activity, or such modified food processing conditions would drastically increase the production cost of such processed foods.

As an alternative, phytase can be delivered to humans together with meals in the form of pills. This is however, not the preferred form since current trend is to avoid the multiplication of the number of pills to be ingested per day.

WO 2002/054881 discloses a beverage tailored to human consumption comprising a phytase. The drink of the above mentioned disclosure is milk. Milk usually contains more than 3% protein and additional factors which are known to the person skilled in the art to stabilize enzymatic activities and therefore the activity of phytase. Indeed, proteins are well known stabilizers of enzymatic activity, which may explain why a certain stability of the phytase was observed in milk. Nevertheless, due to the inherent instability to temperature, light and oxygen of the phytase enzyme in liquid food products the drinks comprising phytase need to be kept chilled or refrigerated. Therefore, this application has been limited up to now to beverages with complex matrix containing protein, and to beverages which are kept chilled or refrigerated.

WO 2004/071218 discloses a food preparation which can be liquid. However, because of phytase instability in liquid, it is limited to protein rich drinks like cow milk and soy milk.

Ready to drink beverages represent the best food category to deliver health benefits to human populations. Phytase supplemented ready to drink beverages have been long awaited by the industry because of the fact that phytase storage stability is inversely correlated with water activity of the food/feed containing phytase.

The goal of the present invention was to find a high water activity ready to drink beverage supplemented with phytase enzyme which could retain enzymatic activity without chilling or refrigeration until reaching its targeted place of activity in the stomach of a human thereby delivering the expected bio-available iron and zinc minerals, and solving the above mentioned problems. Moreover, such an active phytase in a soft drink solves the problem of the cost of pre-treatment of food containing phytate, which is also not always possible when phytate rich meals are prepared locally in developing countries.

The inventors of the present application now surprisingly found that an acidic ready to drink soft drink having a water activity greater than 0.95, and a pH value lower than 6, provides an optimal matrix to stabilize the activity of a phytase enzyme. In the ready to drink beverage of the present invention with limited and even without any protein, the phytase activity remains stable to temperature, and light, and is more resistant to degradation, allowing for the first time to use of active phytase in a ready to drink beverage not refrigerated during, nor after commercialization.

It was not to be foreseen by the person skilled in the art that addition of phytase to this high water activity acidic liquid containing limited amount of fat and/or protein would trigger such an improvement in terms of phytase stability and subsequent mineral bio-availability in human when drunk at the same time or shortly before the ingestion of a meal reach in phytic acid and/or phytate.

Therefore, in a first embodiment, the invention relates to a ready to drink phytate free and alcohol free soft drink having a water activity (Aw) greater than 0.95, a pH value lower than 6, a protein content below 3 wt.-%, and enriched with 10 to 50,000 FTU/litre phytase enzyme.

Water activity or Aw is a measurement of water content. It is defined as the vapour pressure of a liquid divided by that of pure water at the same temperature; therefore, pure distilled water has a water activity of exactly one.

The term “ready to drink” beverage (often known as RTD) is a term used to describe packaged beverages that are sold in a prepared form, ready for consumption. The term includes soft drinks, flavoured water, juice, schorle and spritzer. They usually have a shelf life of 1 to 5 years depending on the type of beverage.

In a preferred embodiment, the ready to drink beverage is a soft drink. The term “soft drink” (also referred to as soda, pop, soda pop, coke or fizzy drink) is a drink that typically contains no alcohol, though may contain small amounts (typically less than 0.5% by volume). Soft drinks are often carbonated and commonly consumed while chilled or at room temperature. Some of the most common soft drinks include cola, flavored water, sparkling water, iced tea, sweet tea, sparkling lemonade (or other lemon-lime soft drinks), squash, fruit punch, root beer, orange soda, grape soda, cream soda, and ginger ale.

The term “soft” is employed in opposition to “hard”, i.e. drinks with high alcoholic content by volume. Generally it is also implied that the drink does not contain milk or other dairy products. Hot chocolate, hot tea, coffee, tap water, juice, schorle or spritzer and milkshakes also do not fall into this classification.

The term “phytase” as used herein denotes phosphatases which specifically split phytic acid in myo-inositol and orthophosphate. A distinction is drawn between 3-phytase and 6-phytase according to the carbon atom at which the orthophosphate is split off the phytic acid. The catalyzed reactions are as follow:

### 3-Phytase (Enzyme EC 3.1.3.8):

myo-inositol hexakisphosphate+H₂O=1D-myo-inositol1,2,4,5,6-pentakisphosphate+phosphate

### 6-Phytase (Enzyme EC 3.1.3.26):

myo-inositol hexakisphosphate+H₂O=1D-myo-inositol1,2,3,4,5-pentakisphosphate+phosphate

According to the present invention 3-phytase food grade, 6-phytase food grade, or mixtures thereof are especially preferred. The phytase of the present invention may come from plant and/or microbiological sources. A preferable plant source for phytase is malt. Preferred phytases from fungal origin are isolated from Aspergillus niger or Peniophora lycii. The fungal enzyme phytase from Aspergillus niger has been commercialized for use in animal feed. Microbial phytases have been isolated from E. coli, B. subtilis, and also from thermostable microbes. Genes encoding the enzymes have been cloned from many micro organisms, and respective enzymes can easily be produced and purified to industrial production scale.

Moreover, phytases can be genetically engineered such that they are more resistant to thermal, light, and/or chemical degradation. Preferred phytase enzymes are Natuphos™ 5000 L, Natuphos™ 5000 G, phytases originating from Peniophora lycii, or synthetic genetically engineered phytases as described in (EP 0 897 985 B1).

The phytase activity is measured in FTU units: 1 FTU (also-called FYT) is the amount of phytase that liberates 1 μmole phosphate per minute at pH 5.5 and 37° C.

The term enriched in Phytase means that exogenous phytase is added to the soft drink in an amount of at least 10 FTU per litre.

In another embodiment, the ready to drink phytate free and alcohol free soft drink of the present invention has a pH comprised between 2.5 and 5.5, preferably between 3 and 5.5, most preferably between 3.5 and 5.

The ready to drink phytate free and alcohol free soft drink of the present invention is acidified using any food grade organic acid, preferably using food-grade citric acid which can be sourced from various commercial suppliers such as Citrique Belge, Tienen. Therefore, in another embodiment, the ready to drink phytate free and alcohol free soft drink of the present invention is characterized in that it contains 0.5 to 4 g/l citric acid.

In another embodiment, the ready to drink phytate free and alcohol free soft drink of the present invention is enriched in phytase with 10 to 20000 FTU per litre, preferably, at least 20, most preferably at least 50 FTU per litre, and preferably, less than 5000 FTU per litre, most preferably less than 2000 FTU per litre.

In another embodiment, the ready to drink phytate free and alcohol free soft drink of the present invention has a total fat content lower than 1 wt.-%, preferably between 0 and 0.5 wt.-%.

In another embodiment, the ready to drink phytate free and alcohol free soft drink of the present invention has a total protein content lower than 3 wt.-%, preferably, lower than 2.5 wt.-%.

In yet another embodiment, Phytase used in the present invention is of microbial origin and is preferably from the fungus Aspergillus, Peniophora lycii, or is a produced from a synthetic genetically engineered consensus gene as described in (EP 0 897 985 B1). Phytase is preferably in a liquid water soluble form (e.g.: glycerol, sorbitol etc), or in a powder/granulate water-soluble form (e.g.: formulated with maltodextrin) and can be added at any time during the production process of the ready to drink soft drink of the present invention.

In another embodiment, the ready to drink phytate free and alcohol free soft drink of the present invention is carbonated. Carbonation refers to the dissolving of carbon dioxide in an aqueous solution. The process usually involves high pressures of carbon dioxide. Upon lowering of this pressure, the carbon dioxide is released from the solution as bubbles. This effect is observed in carbonated beverages. Since the carbonation of aqueous solutions requires pressure, the opening of containers of such solutions is accompanied by an audible pop. Carbonation is used to reduce the availability of free oxygen in a soda, and it can reduce the pH of a liquid by a small amount thereby allowing to prevent the growth of bacteria. Alternatively, the ready to drink soft drink can be aseptically filled, pasteurized according to standard beverage pasteurization conditions, or sterilized by other means known to the person skilled in the art. Other means to achieve microbial stability is aseptic filling or hot filling. Aseptic filling means the filling of cans or other containers with beverages that have already been sterilized, the process thus having to be carried out under aseptic conditions. Continuous sterilization as the beverage passes along narrow pipes (followed by aseptic filling) allows more rapid heating, with less effect on the quality of the beverage, than sterilization by heating after canning. Most preferably, the ready to drink phytate free and alcohol free soft drink of the present invention is carbonated.

In another embodiment, the ready to drink phytate free and alcohol free soft drink of the present invention is further enriched with nutrients, further enzymes, flavouring agents or mixtures thereof.

The term “nutrient” as used herein denotes physiologically essential components of the human diet such as vitamins, e.g., vitamin A, beta-carotene, B vitamins (B1, B2, B3, B5, B6, and/or B12), Folic acid, Niacin, vitamin E, C, Biotin, Pantothenates, vitamin K, vitamin D as well as derivatives and mixtures of these, as well as further minerals and trace elements such as iron, selenium, zinc, calcium, magnesium, and/or manganese. The term nutrient also denotes essential fatty acids, e.g.: Omega-3 fatty acids, such as docosahexaenoic acid (DHA), eicosapentaenoic acid (EPA), polyunsaturated omega-6 fatty acid such as Arachidonic acid, creatine, coenzyme Q10, resveratrol, caffeine, carnitine, and ginseng extract.

creatine, coenzyme Q10, resveratrol, caffeine, carnitine, B vitamins (B1, B2, B3, B5, B6, and/or B12) to a mammal.

The nutrients are usually added in a powdery form, even oily vitamins like vitamin A or vitamin E are preferably used as powdery product forms (e.g. as adsorbates, spray dried powders or beadlets which may contain further ingredients, like matrix components—e.g. hydrocolloids—antioxidants, plasticizers, and/or emulsifiers). Most preferred are water-dispersible powdery product forms of these nutrients.

The ready to drink phytate free and alcohol free soft drink of the present invention may be packed in suitable cans or bottles. The ready to drink phytate free and alcohol free soft drink of the present invention is characterized in that the phytase activity is at least 40%, preferably 50%, more preferably 60%, most preferably 70% of the initial activity after storage of the soft drink for 6 months at 25° C.

The efficacy of the composition of the present invention can be assessed as follows:

Stability of the Phytase activity in a ready to drink beverage can be assessed using a method well established in the art (Animal feeding stuffs; Determination of phytase activity ISO 30024:2009).

Alternatively, indirect efficacy can be assessed by a mineral bioavailability study: absorption of iron can be assessed in vivo in humans using labeled Fe, and applying stable isotope measurement, allowing to assess iron absorption in human subjects as described in (B. Troesch et al., Am J Clin Nutr, 2009; 89: 539-44). This could be accompanied by a plasma response curve where the AUC (area under the curve) of the formulations with and without phytase is compared.

In a further embodiment, a ready to drink phytate free and alcohol free soft drink according to the present invention is used to deliver active phytase to humans, and more specifically for correcting mineral deficiencies in humans. More preferably, the ready to drink phytate free and alcohol free soft drink according to the present invention is used in combination with a meal containing phytic acid and/or phytate. The ready to drink soft drink is best consumed together with the meal, shortly before the meal, or shortly after.

Thus the ready to drink phytate free and alcohol free soft drink based on the current invention helps provide children with the best possible start in life, helps boost children energy, supports skin, hair and nail health, supports a strong immune function, helps boosting the immune system, supports bone health, supports healthy child development, helps keep children grow and thrive, supports healthy cognitive development, supports improved cognition and memory, increases muscle metabolism to boost energy mobilization, improves skeletal muscle mass by stimulating anabolic pathways, inhibiting catabolic pathways and accelerating muscle regeneration when damaged; shifting nutrient usage for energy generation from carbohydrate or protein burning to fat burning; promoting fat burning; acting as a regulator of fat burning, increasing energy expenditure by fatty acid oxidation, increasing fat metabolism, promoting fat oxidation, decreasing body fat and increasing muscle mass; helping to achieve a good silhouette (body shaping), decreasing body fat and increasing lean muscle mass; and increasing thermogenesis; increasing the metabolism of a human to burn more energy;

In another embodiment, a method is provided for correcting mineral deficiency in humans comprising the steps of: a) administering a ready to drink phytate free and alcohol free soft drink having a water activity greater than 0.95, a pH value lower than 6, a protein content below 3 wt.-%, and enriched with 10 to 50000 FTU/litre phytase enzyme, b) observing mineral salts level approach normal.

In yet another aspect of this invention is a method of doing business comprising marketing a ready to drink phytate free and alcohol free soft drink enriched with 10 to 50000 FTU/litre phytase enzyme for sale to a consumer comprising informing the consumer that the ready to drink phytate free and alcohol free soft drink enriched with 10 to 50000 FTU/litre phytase enzyme corrects mineral deficiencies in humans, thereby helping provide children with the best possible start in life, helping boosting children energy, supporting skin, hair and nail health, supporting a strong immune function, helping boosting the immune system, supporting bone health, supporting healthy child development, helping keeping children grow and thrive, supporting healthy cognitive development, supporting improved cognition and memory, increasing muscle metabolism to boost energy mobilization, improving skeletal muscle mass by stimulating anabolic pathways, inhibiting catabolic pathways and accelerating muscle regeneration when damaged; shifting nutrient usage for energy generation from carbohydrate or protein burning to fat burning; promoting fat burning; acting as a regulator of fat burning, increasing energy expenditure by fatty acid oxidation, increasing fat metabolism, promoting fat oxidation, decreasing body fat and increasing muscle mass; helping to achieve a good silhouette (body shaping), decreasing body fat and increasing lean muscle mass; and increasing thermogenesis; and/or increasing the metabolism of a human to burn more energy when drunk in combination with a meal containing phytic acid and/or phytate.

The use may also be in combination with an established pharmacological therapy. The “informing” may be done by printing such information on the packaging, or by a displaying the information in proximity to the composition, or through other separate advertising media which is not in physical proximity to the product, i.e. by television, radio, internet, billboards, or other known advertising methods.

The invention is further illustrated by the following examples.

### EXAMPLES

### Example 1

### Composition of a Flavoured Water

| | | |
|---|---|---|
| Sugar, fine crystalline | 7.2 | g |
| Potassium sorbate | 0.2 | g |
| Citric acid 50% | 2 | g |
| Apricot flavor, 78848-56 Givaudan | 0.2 | g |

| | |
|---|---|
| Phytase 5000 L | 1 ml (5000 FTU) |
| Water | To 1 litre |

### Example 2

### Composition of a Soft Drink

A composition of the present invention comprises the following elements:

| | | |
|---|---|---|
| Sugar sirup (64°Brix) | 156.2 | g |
| Potassium sorbate | 0.2 | g |
| Citric acid 50% | 5.0 | g |
| Apricot flavor, 78848-56 Givaudan | 0.2 | g |

| | |
|---|---|
| Phytase 5000 L | 1 ml (5000 FTU) |
| Water | To 1 litre |

Water is drinking water from Eden Springs, Switzerland with the following composition:

| | | |
|---|---|---|
| Calcium | 35.5 | mg/l |
| Magnesium | 3.1 | mg/l |
| Sodium | 4.1 | mg/l |
| Potassium | 0.7 | mg/l |
| Sulfate | 32.8 | mg/ml |
| Chloride | <0.1 | mg/ml |
| Dry residue at 180° C. | 131 | mg/ml |

### Example 3

### Composition of an Apple Schorle

| | | |
|---|---|---|
| Apple juice concentrate | 91 | g |
| Water | 108.5 | g |

| | |
|---|---|
| Phytase 5000 L | 1 ml (5000 FTU) |
| Carbonated water | To 1 litre |

### Example 4

### Composition of a 10% Orange Juice Drink

| | | |
|---|---|---|
| Potassium sorbate | 0.2 | g |
| Sugar sirup (64°Brix) | 156.2 | g |
| Citric acid 50% | 5 | g |
| Pectin solution 2% w/w | 10 | g |

| | |
|---|---|
| Orange juice concentrate (60°Brix) | 18.7 |
| Orange flavor | 0.2 |
| Phytase 5000 L | 1 ml (5000 FTU) |
| Drink water | To 1 litre |

### Example 5

### Composition of a Ready to Drink Beverage Containing 4% Juice

| | | |
|---|---|---|
| Sugar, fine crystalline | 45 | g |
| Potassium sorbate | 0.2 | g |
| Citric acid 50% | 2 | g |
| Lemon juice from concentrate | 4 | g |

| | |
|---|---|
| Lemon flavor | 0.2 |
| Phytase 5000 L | 1 ml (5000 FTU) |
| Carbonated water | To 1 litre |

### Example 6

### Composition of a Ready to Drink Energy Beverage

| Beverage Base | [g] |
|---|---|
| Water | 35.5 |
| Potassium sorbate | 0.2 |
| Sugar syrup 64°Brix | 156.2 |
| Ascorbic acid | 0.2 |
| Citric acid solution 50% w/w | 5.0 |
| Caffeine | 0.2 |
| Taurin | 0.4 |
| β-Carotene 10% CWS as 1% | 2.0 |
| Stock solution in water w/w | |
| Orange flavour, water soluble | 0.15 |
| Phytase 5000 L | 1 ml (5000 FTU) |
| Water to | 1000.0 ml |

### Example 7

### Composition of a Ready to Drink Sport Beverage (Cherry Sports Drink)

| Ingredients | [g] |
|---|---|
| Sucrose | 10.0 |
| Glucose | 10.0 |
| Fructose | 30.0 |
| Maltodextrin (DE21-23) | 50.0 |
| Potassium sorbate | 0.2 |
| Ascorbic acid, fine powder | 0.2 |
| Citric acid 50% w/w | 5.0 |
| Cherry flavour | q.s. |
| Sodium chloride | 0.8 |
| Calcium lactate | 0.73 |
| Magnesium citrate | 0.6 |
| Potassium phosphate | 0.42 |
| Canthaxanthin 10% CWS/N as 1% | 3.0 |
| stock solution | |
| Phytase 5000 L | 1 ml (5000 FTU) |
| Water to | 1000.0 ml |

### Example 8

### Stability of Phytase in Matrices of Increasing Water Activity

Residual Phytase activity following 6 weeks and 12 weeks storage at 35° C. has been measured in different food products of increasing water content and initially supplemented with 700 FTU/g Phytase (Phytase 5000 L). Table 1 shows an inverse correlation with water activity (Aw) and residual activity (stability) of the phytase after 6 and 12 weeks storage at 35° C. The higher the Aw, the less stable the Phytase activity.

TABLE 1
Phytase activity in food matrices of increasing water activity.

| | | Dry | % residual | % residual |
|---|---|---|---|---|
| | | matter | activity | activity |
| Product | Aw | (%) | after 6 weeks | after 12 weeks |
| Nido milk powder | 0.197 | 99.64 | 75 | 68 |
| Mild curry | 0.303 | 96.00 | 66 | 55 |
| Nesquick | 0.347 | 99.64 | 57 | 43 |
| Honig binding powder | 0.418 | 92.94 | 49 | 31 |
| Instant chicken soup | 0.503 | 95.80 | 39 | 23 |
| White wheat flour | 0.541 | 88.73 | 40 | 21 |

### Example 9

### Stability of Phytase in an Acidic Soft Drink at Different Temperatures and pH

Phytase (Phytase 5000 L) was applied in two concentrations: 2000 FTU/l and 8000 FTU/l in buffer solution (pH 5.5, as a reference) and in soft drinks with different pH values; 2.5 and 3.5. The soft drinks were stored in glass bottles at room temperature and at 40° C. Phytase activity was measured at different time points during storage.

### Material and Methods:

Phytase:

Phytase 5000 L (liquid form)

Buffer Solution (pH 5.5):

250 mM sodium acetate with 0.01% Tween 20

Soft Drinks:

A soft drink of the composition as described in example 2 (with exception of Phytase content adjusted to 2000 or 8000 FTU/l) was used in this experiment.

### Preparation of the Bottling Syrup:

Potassium sorbate was added to a 11 volumetric flask and dissolved with demineralized water. Sugar syrup, citric acid and apricot flavour were added one by one. After each addition, the solution was gently mixed using a magnetic stirrer.

### Preparation of the Beverage:

The bottling syrup was diluted with drink water (a little less than 1 litre) and the pH was adjusted. HCl solution was used to adjust the pH to 2.5 and NaOH solution was used for pH 3.5. After pH adjustment, drink water was added to 1 l. Buffer and beverages were enriched with Phytase in two concentrations, A₀=2000 FTU/l and A₀=8000 FTU/l and distributed in glass bottles (0.2 l). The bottles were then plugged with a crown cap.

### Enzyme Activity Measurements:

0.4 ml in 0.25 M sodium acetate and 0.01% Tween-20, pH 5.5 diluted enzyme samples were added into Eppendorf tubes and pre-incubated at 37° C. 0.8 ml pre-incubated substrate solution (7.5 mM sodium phytate from Sigma in 0.25 M sodium acetate pH 5.5) was added to start the reaction. After 30 min at 37° C., the reaction was stopped by adding 0.8 ml molybdate/vanadate stop reagent. Absorbance was measured at 415 nm. One phytase unit (U) is the amount of enzyme that releases 1 μmol of inorganic phosphate from phytate per minute under the chosen reaction conditions. All samples were measured in duplicate.

### Results:

Table 2 shows the percentage of residual phytase activity at different time points and different pH values when the soft drinks were stored at room temperature with 2 different concentrations of phytase.

TABLE 2
Retention of phytase activity expressed in % of residual activity
at different time points (7, 14, 21, 42 days) at different pH (3.5
and 2.5) when soft drinks were stored at room temperature. Data is
shown for 2 concentrations of phytase (2000 and 8000 FTU/l).

| | | storage time (days) | | | | |
|---|---|---|---|---|---|---|
| | | 0 | 7 | 14 | 21 | 42 |
| 2000 | Buffer pH 5.5 | 100 | 101 | 102 | 100 | 98 |
| FTU/l | Soft drink pH 3.5 | 100 | 96 | 95 | 90 | 82 |
| | Soft drink pH 2.5 | 100 | 95 | 89 | 85 | 76 |
| 8000 | Buffer pH 5.5 | 100 | 101 | 97 | 99 | 97 |
| FTU/l | Soft drink pH 3.5 | 100 | 99 | 96 | 92 | 88 |
| | Soft drink pH 2.5 | 100 | 98 | 91 | 86 | 76 |

In buffer solution stored at room temperature, phytase activity remained constant during 42 days. In soft drinks, phytase activity decrease during storage. In soft drink with higher pH, retention was higher than in soft drink with lower pH. The initial concentration of phytase (A₀) showed no significant influence on the results; results obtained for A₀=2000 Units/l were very similar to results obtained for A₀=8000 Units/l. Therefore, the stability is most likely not related to the protein content of the soft drink.

Table 3 shows the percentage of residual phytase activity at different time points and different pH values when the soft drinks were stored at 40° C. with 2 different concentrations of phytase.

TABLE 3
Retention of phytase in non-pasteurized
buffer and soft drinks, stored at 40° C.

storage time (days)

| | | 0 | 7 | 14 | 21 | 42 |
|---|---|---|---|---|---|---|
| 2000 | Buffer pH 5.5 | 100 | 83 | 77 | 74 | 66 |
| FTU/l | Soft drink pH 3.5 | 100 | 86 | 72 | 58 | 19 |
| | Soft drink pH 2.5 | 100 | 47 | 27 | 14 | 0 |
| 8000 | Buffer pH 5.5 | 100 | 75 | 67 | 65 | 56 |
| FTU/l | Soft drink pH 3.5 | 100 | 91 | 83 | 74 | 46 |
| | Soft drink pH 2.5 | 100 | 50 | 29 | 19 | 7 |

### CONCLUSIONS

The results were very surprising, since the retention of the activity of phytase in beverages was much higher than expected for a system with very high water activity (Aw˜1). After 42 days storage at room temperature, in non-pasteurized soft drinks with pH 2.5, retention was approximately 75% and in non-pasteurized soft drinks with pH 3.5, about 85%.

### Example 10

### Stability of Phytase in an Acidic Soft Drink in PET-Bottles at Different pH

Phytase (Phytase 5000 L) was applied at the concentration of 2000 FTU/l in buffer solution (pH 5.5, as a reference) and in soft drinks with different pH values: 2.5 and 3.5. The soft drinks were stored in PET-bottles at room temperature (25° C.). Phytase activity was measured at different time points during storage.

### Material and Methods:

Phytase: Phytase 5000 L (Liquid Form)

### Buffer Solution (pH 5.5):

250 mM sodium acetate with 0.01% Tween 20.

### Soft Drinks:

| | Soft drink | Soft drink |
|---|---|---|
| ingredients | pH 2.5 [g] | pH 3.5 [g] |
| Sugar syrup 64°Brix | 156.2 | 156.2 |
| Potassium sorbate | 0.2 | 0.2 |
| Citric acid 50% solution w/w | 5.0 | 5.0 |
| Apricot flavour 78848-56 Givaudan | 0.2 | 0.2 |
| Phytase euphovida 5000L | 0.4 | 0.4 |
| HCL 1N | 4.5 | — |
| NaOH 1N | — | 8.1 |
| Carbonated water to | 1000.0 | 1000.0 |

### Preparation of the Bottling Syrup:

Potassium sorbate was added to a 1 l volumetric flask and dissolved with demineralized water. Sugar syrup, citric acid and apricot flavour were added one by one. After each addition, the solution was gently mixed using a magnetic stirrer. Either HCL 1N for pH 2.5 adjustment or NaOH 1N for pH 3.5 was added to the bottling syrup.

### Preparation of the Beverage:

For the beverages a bottling syrup was prepared (see above).

Individual bottles were filled with corresponding amount of syrup. Syrup was diluted with carbonated water to final strength, Phytase solution was added individually to each bottle, bottles were closed with a screw cap and agitated carefully to get a homogeneous distribution of the Phytase in the beverage. CO₂-content in water was approximately 7 g/l.

Enzyme Activity Measurements:

0.4 ml in 0.25 M sodium acetate and 0.01% Tween-20, pH 5.5 diluted enzyme samples were added into Eppendorf tubes and pre-incubated at 37° C. 0.8 ml pre-incubated substrate solution (7.5 mM sodium phytate from Sigma in 0.25 M sodium acetate pH 5.5) was added to start the reaction. After 30 min at 37° C., the reaction was stopped by adding 0.8 ml molybdate/vanadate stop reagent. Absorbance was measured at 415 nm. One phytase unit (U) is the amount of enzyme that releases 1 μmmol of inorganic phosphate from phytate per minute under the chosen reaction conditions. All samples were measured in duplicate.

### Results:

Table 4 shows the percentage of residual phytase activity at different time points (in weeks), and different pH values when the soft drinks were stored at room temperature (25° C.).

TABLE 4

| | Storage time (weeks) | | | | | | | |
|---|---|---|---|---|---|---|---|---|
| | 0 | 1 | 2 | 3 | 6 | 12 | 26 | 43 |
| Buffer pH 5.5 | 100 | 95 | 96 | 95 | 96 | 92 | — | 92 |
| Soft drink pH 3.5 | 100 | — | — | 101 | 98 | 97 | 92 | 92 |
| Soft drink pH 2.5 | 100 | — | — | 78 | 67 | 54 | — | 29 |

The phytase stability in carbonated soft drinks was very good for pH 3.5 and the buffer.

1. Ready to drink phytate free and alcohol free soft drink having a water activity greater than 0.95, a pH value lower than 6, a protein content below 3 wt.-%, and enriched with 10 to 50000 FTU/litre phytase enzyme.

2. A ready to drink phytate free and alcohol free soft drink according to claim 1, characterized in that the pH is comprised between 2.5 and 5.5.

3. A ready to drink phytate free and alcohol free soft drink according to any of the claim 1 or 2, characterized in that the pH is comprised between 3 and 5.5.

4. A ready to drink phytate free and alcohol free soft drink according to any of the claims 1 to 3, characterized in that it contains 0.5 to 4 g/l citric acid.

5. A ready to drink phytate free and alcohol free soft drink according to any of the claims 1 to 4, characterized in that it is enriched with 50 to 20000 FTU per litre.

6. A ready to drink phytate free and alcohol free soft drink according to any of the claims 1 to 5, characterized in that the fat content is lower than 1 wt.-%.

7. A ready to drink phytate free and alcohol free soft drink according to any of the claims 1 to 6, characterized in that the phytase is of microbial origin and is preferably from the fungus Aspergillus.

8. A ready to drink phytate free and alcohol free soft drink according to any of the claims 1 to 7, characterized in that it is aseptically filled, pasteurized or carbonated.

9. A ready to drink phytate free and alcohol free soft drink according to any of the claims 1 to 8, characterized in that it is further enriched with nutrients, further enzymes, flavoring agents, or mixtures thereof.

10. A ready to drink phytate free and alcohol free soft drink according to any of the claims 1 to 9, characterized in that the phytase activity is at least 50% of the initial activity after storage of the soft drink for 6 months at 25° C.

11. Use of a ready to drink phytate free and alcohol free soft drink according to any of the claims 1 to 10 to deliver active phytase to humans.

12. Use of a ready to drink phytate free and alcohol free soft drink according to any of the claims 1 to 10 to deliver at least 150 FTU of phytase to humans.

13. The use of a ready to drink phytate free and alcohol free soft drink according to any of the claims 1 to 12 for correcting mineral deficiencies in humans.

14. The use of a ready to drink phytate free and alcohol free soft drink according to any of the claims 1 to 13 in combination with a meal containing phytic acid and/or phytate.

15. Method of correcting mineral deficiencies in humans comprising the steps of:
a) administering a ready to drink phytate free and alcohol free soft drink having a water activity greater than 0.95, a pH value lower than 6, a protein content below 3 wt. %, and enriched with 10 to 50000 FTU/litre phytase enzyme.
b) observing mineral salts level approach normal.

16. A method of doing business comprising marketing a ready to drink phytate free and alcohol free soft drink enriched with 10 to 50000 FTU/litre phytase enzyme for sale to a consumer comprising: informing the consumer that the ready to drink phytate free and alcohol free soft drink enriched with 10 to 50000 FTU/litre phytase enzyme corrects mineral deficiencies in humans when drunk in combination with a meal containing phytic acid and/or phytate.

17. A method according to claim 16 wherein the informing is done by printing such information on the packaging, or by a displaying the information in proximity to the composition, or by advertising media which is not in physical proximity to the product.
